(19) United States
(12) Patent Application Publication
(10) Pub. No.: US 2024/0028046 A1
(43) Pub. Date: Jan. 25, 2024

(54) VEHICLE CONTROL SYSTEM

(71) Applicant: Transportation IP Holdings, LLC, Norwalk, CT (US)

(72) Inventors: Matthew Vrba, Marion, IA (US); Brett Trombo-Somerville, Beausejour (CA); Amanda Elkin, Cedar Rapids, IA (US); Jeremy Blackwell, Cedar Rapids, IA (US)

(21) Appl. No.: 18/330,833

(22) Filed: Jun. 7, 2023

Related U.S. Application Data
(60) Provisional application No. 63/391,181, filed on Jul. 21, 2022.

(51) Int. Cl. G05D 1/02

(52) U.S. Cl. CPC G05D 1/0276; G05D 1/0278; G05D 1/027

(57) ABSTRACT

A system is provided to initialize a vehicle for movement under or with the protection of a vehicle control system. The system may determine a sensed location of a vehicle based off one or more location signals received from an off-board source, and calculate a location of the vehicle responsive to the vehicle moving into a blocking structure where the vehicle does not determine the sensed location of the vehicle based off the one or more location signals. The calculated location of the vehicle may be calculated using one or more sensor outputs. A route is selected from among several routes within the blocking structure based on the calculated location. The selected route is communicated to a back-office system, and movement of the vehicle is controlled using one or more control signals received from the back-office system that are based on the route that is selected.

### CROSS-REFERENCE TO RELATED APPLICATIONS

This application claims priority to U.S. Provisional Application No. 63/391,181 (filed 21 Jul. 2022), the entirety of which is incorporated herein by reference.

### BACKGROUND

### Technical Field

The subject matter described herein relates to systems that control operation of vehicles.

### Discussion of Art

Many vehicles rely on tracking or knowing locations of the vehicles in controlling movement of the vehicles. For example, many vehicles and different types of vehicles (e.g., automobiles, rail vehicles, buses, trucks, mining vehicles, manned or unmanned aircraft, agricultural vehicles, marine vessels, etc.) may use navigation systems to control when, where, and how the vehicles move along routes between locations.

As one example of such a navigation system, some rail vehicles may use vehicle control systems to control where, when, and/or how the rail vehicles may move to avoid collisions between the vehicles, to avoid moving in unsafe manners (e.g., too fast through curves or through areas where maintenance crews are present, etc.), and the like. One example of such a navigation system is a Positive Train Control (PTC) system. The PTC system includes both off-board and onboard components. Vehicles report positions, speeds, etc. to the off-board component of the PTC system. The off-board component monitors the movements of many vehicles based on these reports, and sends instructions (e.g., movement authorities) that inform the onboard components of which segments of routes that the vehicles can safely enter into, how fast the vehicles can move in different segments of the routes, etc., to prevent collisions and/or ensure the vehicles are otherwise moving in safe ways.

For these control systems to be able to operate, the control systems may require that an initial or starting location of a vehicle be known. For example, the PTC system may need to know which track a rail vehicle is starting a trip. Currently, the control systems may require that a global navigation satellite system (GNSS) signal be received to determine the possible starting location of the vehicle. The GNSS signal can be a signal that includes or represents a geographic position (latitude, longitude, and/or altitude) of the vehicle, and can be obtained by a GNSS receiver (e.g., a Global Positioning System, or GPS, receiver) onboard the vehicle that receives signals from off-board GNSS components (e.g., GNSS satellites).

One issue with requiring and relying on GNSS signals to determine a vehicle location is that there may be locations where GNSS signals are not available. For example, a vehicle may not be able to determine or report a GNSS-based location while the vehicle is located in or below structures such as underground stations, platforms with metal awnings, stations under buildings, parking lots, underpasses, trenches, tunnels, etc. Some control systems may be able to rely on the last known location of the vehicles, such as the last reported location of a vehicle when the vehicle ended the prior trip. There are, however, are limitations on when the last known location can be stored and used for a new trip, including the lack of a quality wheel tachometer and movement of the vehicle since the prior trip. Additionally, there may be times when the vehicle is a multi-vehicle system formed from several vehicles, and control of the multi-vehicle system may switch from one vehicle (e.g., a locomotive at one end of a train) to another vehicle (e.g., a locomotive at the opposite end of the train). As these controlling vehicles are necessarily in different locations, the last known location of the prior controlling vehicle may not be useful for initiating control by the control system when the next trip begins.

While some known control systems may rely on the addition of sensors, new signals and/or sources of those signals to determine locations of vehicles in GNSS dark areas (areas where GNSS signals cannot be received from the off-board sources), these other known control systems may increase the cost and complexity of operating the vehicles. It may be desirable to have a vehicle control system and method that differs from those that are currently available.

### BRIEF DESCRIPTION

In one example, a method (e.g., for initializing a vehicle for movement under or with the protection of a vehicle control system) is provided. The method may include determining a sensed location of a vehicle based off one or more location signals received from an off-board source, and calculating a calculated location of the vehicle responsive to the vehicle moving into a blocking structure where the vehicle does not determine the sensed location of the vehicle based off the one or more location signals. The calculated location of the vehicle may be calculated using one or more sensor outputs. The method also may include selecting a route from among several routes within the blocking structure based on the calculated location, communicating the route that is selected to a back-office system, and controlling movement of the vehicle using one or more control signals received from the back-office system that are based on the route that is selected.

In one example, a system (e.g., a vehicle control system) is provided. The system may include one or more controllers that may determine a sensed location of a vehicle based off one or more location signals received from an off-board source. The one or more controllers may calculate a calculated location of the vehicle responsive to the vehicle moving into a blocking structure where the vehicle does not determine the sensed location of the vehicle based off the one or more location signals. The calculated location of the vehicle may be calculated using one or more sensor outputs. The one or more controllers may select a route from among several routes within the blocking structure based on the calculated location and to communicate the route that is selected to a back office system, and may control movement of the vehicle using one or more control signals received from the back office system that are based on the route that is selected.

In one example, a method may include determining sensed locations of a vehicle while the vehicle receives GNSS signals, sensing movement of the vehicle using one or more inertial measurement sensors, calculating one or more calculated locations of the vehicle based on at least one of the sensed locations and the movement of the vehicle that is sensed using the one or more inertial measurement sensors and responsive to no longer receiving the GNSS signals, selecting a route from several different routes as a beginning route for a trip of the vehicle (where the beginning route is selected based on the one or more calculated locations), initializing the vehicle for the trip by communicating the beginning route of the vehicle to an off-board system of a positive control system, and controlling movement of the vehicle based on one or more control signals received from the off-board system responsive to initializing the vehicle for the trip.

### BRIEF DESCRIPTION OF THE DRAWINGS

The subject matter may be understood from reading the following description of non-limiting embodiments, with reference to the attached drawings, wherein below:

FIG. 1 illustrates one example of a network of routes extending into and/or through a blocking structure;

FIG. 2 illustrates one example of a vehicle control system;

FIG. 3 illustrates one example of route selection for reporting to an off-board component of a positive (or negative) control system during or for trip initialization;

FIG. 4 illustrates another example of route selection for reporting to the off-board component of the positive (or negative) control system during or for trip initialization;

FIG. 5 illustrates another example of route selection for reporting to the off-board component of the positive (or negative) control system during or for trip initialization; and

FIG. 6 illustrates a flowchart of one example of a method for determining locations of vehicles.

### DETAILED DESCRIPTION

Embodiments of the subject matter described herein relate to vehicle control systems and methods that determine locations of vehicles. This may occur in areas where the vehicles may be unable to accurately (e.g., correctly) and/or precisely (e.g., with an acceptable range of error) determine the locations of the vehicles. These determined locations may then be used by the vehicle control systems to assist the vehicles in safe movement, such as by instructing onboard components of the vehicle control systems when, where, and/or how the vehicles can safely travel through or on different segments of routes. In one embodiment, the vehicle control system and method may rely on existing components already onboard a vehicle to determine locations (e.g., initial locations before a trip is begun) without having to add more components, rely on additional signals from an off-board source, etc.

As one example, existing navigation devices may operate in conjunction with GNSS receivers to determine locations of vehicles in the absence of GNSS signals. For example, an inertial measurement unit (IMU, such as the WABTEC GoLINC precise navigation module, or PNM) can determine a geographic position of a vehicle in the absence of receiving GNSS signals from off-board sources (e.g., GNSS satellites). This geographic position or location can be determined based on the inertial data output by the IMU and a previously determined (e.g., the last known) GNSS geographic position or location. For example, the navigation device can measure the heading and speed of the vehicle. Based on this heading and speed at which the vehicle moves from the last known GNSS-derived location, the current or new location of the vehicle (e.g., in or within an area where GNSS signals cannot be received) can be determined. This location can be reported to the vehicle control system and used to begin monitoring the movement of the vehicle (for creating movement authorities or other restrictions that ensure that safe movement of that vehicle and other vehicles).

In situations where the vehicle control system is starting or initializing for a new trip, the vehicle control system may use the geographic location of the vehicle that is determined from the navigation device in the absence of GNSS signal reception to determine the possible route locations where the vehicle might be located. Optionally, the navigation device can calculate a position error (e.g., a standard deviation or other error calculation) that indicates several possible locations (e.g., an area) where the vehicle may be located based on the last known GNSS location and the information measured by the navigation device (e.g., heading and moving speed since the last known GNSS location was determined). This error may extend over or encompass one or more routes. For example, the error may be represented by a circle, sphere, or other shape that overlaps with one or more routes (e.g., on a two-dimensional or three-dimensional map). Depending on the number of routes that the error overlaps, the off-board and/or onboard components of the vehicle control system may automatically identify the route on which the vehicle is located, may select a set of routes for presentation to one or more onboard operators for selection of which route the vehicle is located on, or may determine that the component(s) are unable to automatically identify or select a set of routes for presentation to the operator(s). For example, if the error bounds (e.g., the circle, sphere, or other shape) overlaps a single route, the system may automatically select the route on which the vehicle is located (as that single route). If the error bounds overlap multiple routes (e.g., two or more neighboring parallel tracks, lanes of a road, parallel roads, etc.), then the system may present a list or map of these routes that overlap with the error bounds for presentation and selection by the operator(s). In one example, if the error bounds overlap many routes (e.g., more than a threshold number, such as three in one embodiment), then the system may determine that the system is unable to identify the route on which the vehicle is located. Alternatively, if the error bounds overlap many routes (e.g., more than the threshold number), then the system may still present these routes that overlap the error bounds for presentation and selection by the operator(s). With the route on which the vehicle is located being selected, the off-board components of the vehicle control system may begin tracking movements of the vehicle. This allows the vehicle control system to warn or restrict movements of other vehicles based on movements of the vehicle having the selected route, as described herein.

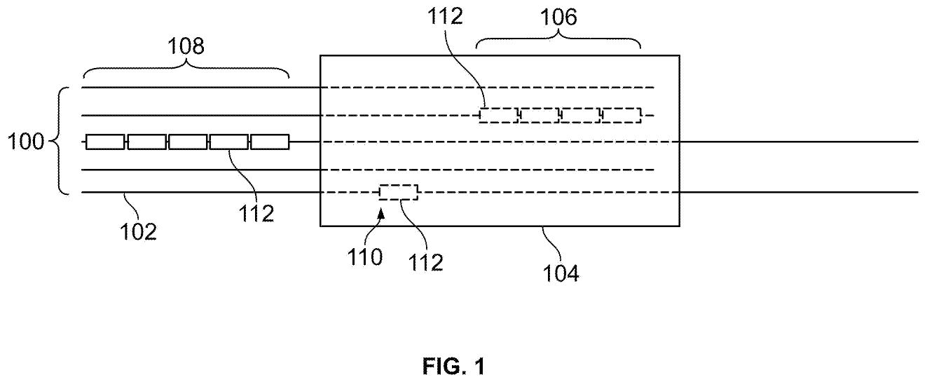

FIG. 1 illustrates one example of a network 100 of routes 102 extending into and/or through a blocking structure 104. The routes can represent roads, tracks, lanes of the same or neighboring roads, paths, waterways, or other vehicle routes on which vehicle systems 106, 108, 110 may travel. The vehicle systems can represent a single vehicle 112 (e.g., the vehicle system 110) or multi-vehicle systems (e.g., the vehicle system 106 and/or 108) formed from multiple vehicles. The vehicles in the multi-vehicle system can be mechanically coupled with each other or may remain separate but coordinate movements so that the vehicles in the vehicle system move together (e.g., in a platoon, convoy, swarm, etc.). The vehicles can be propulsion-generating vehicles (e.g., automobiles, trucks, locomotives, etc.). In the multi-vehicle systems, one or more (but fewer than all) of the vehicles can represent non-propulsion-generating vehicles (e.g., trailers, railcars, etc.). The structure can represent any man-made or natural object that can interfere with, or block reception of location signals sent by off-board sources (e.g., GNSS satellites). For example, the structure can represent a building, parking lot, canopy, tunnel, ravine, valley, mountain, trees, etc. that partially or entirely block transmission of GNSS satellites to GNSS receivers onboard the vehicle systems. As another example, the blocking structure can represent a non-physical blocking or impedance to transmission of the GNSS signals. For example, GNSS signals may be blocked through GNSS jamming where other signals are intentionally or unintentionally transmitted and jam or otherwise interfere with transmission of the GNSS signals. The vehicles may be unable to receive the GNSS signals while the vehicle systems are beneath or within the structure (e.g., or within an area where other signals are jamming or interfering with the GNSS signals).

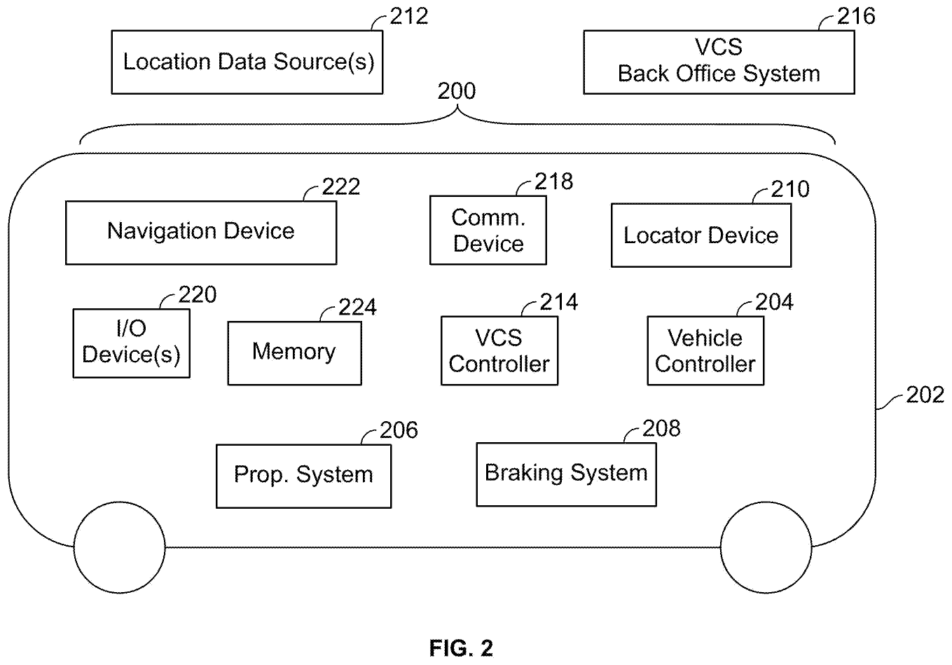

With continued reference to the vehicle systems and structure shown in FIG. 1, FIG. 2 illustrates one example of a vehicle control system 200. The vehicle control system may be off-board and/or onboard a vehicle 202, such as a propulsion-generating vehicle. The vehicle shown in FIG. 2 can represent one or more of the vehicles in the vehicle systems shown in FIG. 1. One or more components of the vehicle control system may be off board the vehicle while one or more other components of the vehicle control system may be onboard the vehicle. Alternatively, all components of the vehicle control system may be onboard the vehicle.

A vehicle controller 204 controls the operation (e.g., movement) of the vehicle. The vehicle controller can represent hardware circuitry that includes and/or is connected with one or more processors (e.g., microprocessors, integrated circuits, field programmable gate arrays, etc.) that perform the operations described in connection with the vehicle controller. For example, the vehicle controller can communicate with a propulsion system 206 (“Prop. System” in FIG. 2, such as one or more engines, motors, or the like) to control propulsion of the vehicle and vehicle system, and/or a braking system 208 (e.g., one or more friction brakes, air brakes, or the like) to slow or stop movement of the vehicle and vehicle system.

A locator device 210 may determine the geographic locations of the vehicle. In one embodiment, the locator device communicates with one or more location data sources 212 that are off board the vehicle to determine the locations of the vehicle. For example, the location data sources can represent GNSS satellites or beacons that broadcast signals that are received by the locator device (e.g., a GNSS or GPS receiver). The locator device can determine the location, heading, speed, etc. of the vehicle based on these signals. Alternatively, the locator device can include a sensor that detects one or more characteristics to determine the locations of the vehicle. For example, the locator device can represent a radio frequency identification (RFID) reader that reads an RFID tag associated with a known location to determine the vehicle location. As another example, the locator device can represent an optical sensor, such as a camera, that optically reads where the vehicle is located (e.g., from one or more signs, such as waypoints, road signs, etc.). In one example, the locator device (and/or the vehicle controller) can apply one or more filters to the signals received from the location data source(s), such as a Kalman filter.

A vehicle control system controller 214 (“VCS Controller” in FIG. 2) represents an onboard component of the vehicle control system. The VCS controller can communicate with an off-board component of the vehicle control system, such as a vehicle control system back-office system 216 (“VCS Back Office System” in FIG. 2). The VCS controller and the back-office system can communicate with each other via a communication device 218 (“Comm. Device” in FIG. 2), which can represent hardware transceiving circuitry, such as a transceiver, modem, antenna, and the like. The back-office system also can include a communication device 218 to allow for communication with the vehicles. The VCS controller can represent hardware circuitry that includes and/or is connected with one or more processors. The VCS controller can communicate with the back-office system to report locations of the vehicle, moving speeds of the vehicle, headings or directions of movement of the vehicle, etc. The VCS controller also can receive directive signals from the back-office system. These signals can include movement restrictions, such as movement authorities that dictate where, when, and/or how the vehicle can move. The back-office system can determine whether to allow different vehicles to enter into different route segments and/or how the vehicles can move in those segments based on reported locations, speeds, and/or headings of the vehicles, as well as reported areas of the routes undergoing repair, maintenance, etc.

For example, the back-office system and the VCS controller can be components of a positive control system that sends movement authorities to vehicles to inform the vehicles whether the vehicles can travel into an upcoming segment of a route, how fast the vehicles can move in the upcoming segment of the route, etc. If the VCS controller receives a permissive movement authority from the back office system indicating that the vehicle can enter into the upcoming segment, then the VCS controller can inform the operator (e.g., via an input and/or output device 220, or “I/O Device” in FIG. 2) of whether the vehicle can move into the upcoming segment (and optionally how fast the vehicle can move in the upcoming segment). Optionally, the VCS controller can allow the vehicle to move into the upcoming segment responsive to receiving the movement authority. But if the VCS controller does not receive the movement authority, then the VCS controller may inform the operator of the vehicle and/or generate signals to automatically control the propulsion system and/or braking system to prevent the vehicle from entering into the upcoming segment of the route and/or to prevent the vehicle from moving in the upcoming segment of the route in a way that violates the movement authority (e.g., moving faster than the movement authority dictates).

As another example, the back-office system and the VCS controller can be components of a negative control system that sends movement authorities to vehicles to inform the vehicles where the vehicles cannot travel. If the VCS controller receives a movement authority from the back-office system indicating that the vehicle cannot enter into the upcoming segment, then the VCS controller can inform the operator and/or automatically control the propulsion system and/or braking system to prevent disallowed movement of the vehicle in the upcoming segment. If the VCS controller does not receive the movement authority from the back-office system indicating that the vehicle cannot enter into the upcoming segment, then the VCS controller can inform the operator and/or allow movement of the vehicle in the upcoming segment.

A navigation device 222 can determine locations of the vehicle based off information other than or in addition to the off-board signals received from the location data source(s). For example, the navigation device can include or represent one or more sensors that detect movement of the vehicle. These sensors can include one or more IMUs, accelerometers, magnetometers, tachometers (e.g., wheel and/or other tachometers), etc. The navigation device optionally can include one or more processors that examine the information sensed by the sensors to determine the movement and/or change in location of the vehicle. Alternatively, the navigation device may include the sensor(s) but may send the output from the sensor(s) to the VCS controller and/or the vehicle controller to calculate the location of the vehicle based on the sensor output. The navigation device and/or the vehicle controller can apply one or more filters, such as a Kalman filter, to the output of the sensor(s). In one embodiment, the navigation device (or the controller(s)) can employ a dead reckoning calculation, a wireless triangulation calculation, or the like, to monitor or determine the location(s) of the vehicle in locations and/or during times when the locator device is unable to do so and/or the locator device is unable to receive the signals from the location data source(s).

The I/O device referred to above can represent a display screen, a touchscreen, a speaker, or the like, which is used to communicate information with an operator onboard the vehicle. A tangible and computer-readable storage medium (e.g., a computer hard drive, disc, removable memory, etc.), or memory 224, optionally can be onboard the vehicle. This memory can store information determined by the navigation device, controller(s), and/or locator device, such as a last-known location determined from the off-board signals received from the location data source(s), the location determined by the navigation device or controller(s) based on the output from the navigation device (e.g., the dead-reckoning determined location), or the like. The memory optionally can store route layouts, such as a map or other information on the locations, curves, paths, etc. of various routes on which the vehicle may or will travel.

In operation, the control system can initiate a trip of the vehicle (or a multi-vehicle system that includes the vehicle) by obtaining one or more off-board signals from the location data source(s) and determine the geographic location of the vehicle. The VCS controller can examine this location and the route layouts (e.g., as obtained from the memory and/or received from a communication from the back-office system) to determine which route the vehicle is located. For example, the VCS controller can determine whether the geographic location of the vehicle as determined by the locator device is on or near a route (e.g., within a threshold distance, such as three meters or a distance between neighboring routes). The VCS controller can identify this route as the route currently occupied by the vehicle and on which the vehicle will begin the trip. The VCS controller can communicate this identified route to the back-office system so the back-office system can determine where the vehicle is located to determine which route segments that the vehicle can enter into, how fast the vehicle can move through the route segments, and the like.

During movement of the vehicle, the vehicle may enter the blocking structure described above. This can impede or prevent the locator device from being able to receive signals from the location data source(s) and, therefore, determine the location of the vehicle. If the vehicle is pausing or ending a trip in the blocking structure, then the locator device may be unable to determine the location of the vehicle when the next trip begins. This can prevent the VCS controller from reporting the location of the vehicle to the back-office system, which can result in the back-office system being unable to determine where the vehicle is located, and which route the vehicle is beginning a trip on. Consequently, the back-office system may not be able to inform the VCS controller of which route segments to travel on and/or how fast to move. In short, the back-office system may not be able to provide the protection that the back-office system would be able to if the starting location of the vehicle was known.

To prevent this from occurring, the navigation device, VCS controller, and/or vehicle controller can determine a last-known location of the vehicle from the locator device before the locator device is unable to determine the location of the vehicle. For example, prior to entering the blocking structure, the locator device may provide a geographic location of the vehicle outside of the blocking structure. This last-known location may be a location that is just outside the blocking structure (e.g., within ten meters of an exterior of the blocking structure) or farther from the blocking structure.

The navigation device, VCS controller, and/or vehicle controller can use this last-known location, as well as the speed and/or heading of the vehicle (as determined by the navigation device), to calculate one or more additional locations of the vehicle within the blocking structure. The navigation device, VCS controller, and/or vehicle controller can use dead-reckoning calculations to approximate the location of the vehicle within the blocking structure. The location of the vehicle determined from the locator device can be referred to as the sensed location due to the location being determined based off signals sensed (e.g., received) from off-board or external locations, such as the location data source(s). The location(s) of the vehicle that is or are determined from the output from the navigation device (e.g., the location(s) determined using dead reckoning) may be referred to as calculated locations as these locations are calculated by the vehicle (based off of output from a device onboard the vehicle, such as the navigation device). The VCS controller, navigation device, and/or vehicle controller can calculate the calculated locations until the vehicle stops within the blocking structure or can calculate the calculated location once the vehicle has stopped within the blocking structure.

This calculated location (or the last calculated location) can then be used to initialize the VCS controller for controlling movement of the vehicle during a subsequent trip. For example, prior to the vehicle or vehicle system beginning another trip starting inside the blocking structure, the vehicle or vehicle system may need to communicate the starting location and/or identification of the route on which the vehicle or vehicle system is located. This information is received by the back-office system, and the back-office system can send a confirmatory signal to the VCS controller to notify that controller that the location and movement of the vehicle or vehicle system is being tracked by the back-office system. This confirms that the back-office system can continue to issue signals to the vehicle to ensure the safe movement of the vehicle (or vehicle system that includes the vehicle).

In one embodiment, the memory may store route locations and layouts, including those routes inside a blocking structure. The VCS controller, vehicle controller, and/or navigation device can automatically select the route on which the vehicle (or vehicle system) is located based on the calculated location of the vehicle (e.g., that is determined after the vehicle has stopped). For example, the VCS controller can select the route from among several routes based on which route the calculated location is disposed. Optionally, one or more routes may be recommended for selection by an operator (and for reporting to the back-office system during trip initialization) based on the calculated location that is determined. For example, the VCS controller can identify one or more routes that are near (e.g., within a threshold distance, such as an error bound or standard deviation) of the calculated location. These routes may be potential routes for selection, and can be presented to an operator (e.g., via the I/O device) for selection.

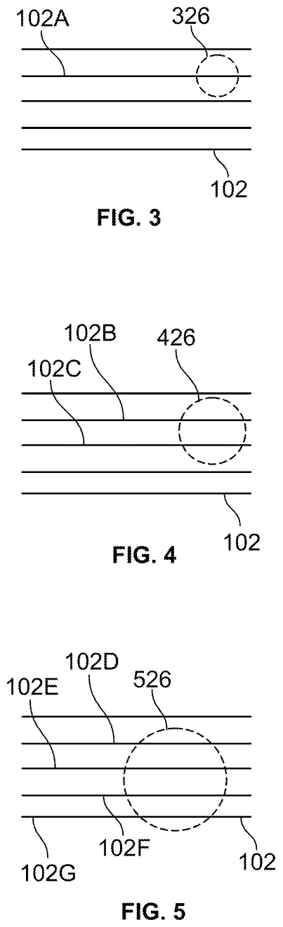

FIGS. 3 through 5 illustrate different examples of route selection for reporting to the back-office system during or for trip initialization. In each of these examples, there are several nearby routes that may be within the blocking structure. A circle 326, 426, 526 in each of FIGS. 3 through 5 indicates the error range of the location of the vehicle that is calculated using the last known sensed location, along with the output from the navigation device. For example, these circles can represent the standard deviation or designated number of standard deviations (e.g., two or three standard deviations) of the calculated location based on the dead reckoning calculation used to calculate the stopping location of the vehicle. The circle in FIG. 3 is smaller than the circle in each of FIG. 4 and Figure while the circle in FIG. 5 is the largest of the circles in FIGS. 3 through 5. This can indicate that the estimated amount of error of the calculated location is greatest in the example of FIG. 3 and the lowest in the example of FIG. 5.

There can be different error ranges for different calculated locations due to a variety of factors. One example of a factor is the speed at which the vehicle was moving after the last known sensed location was determined (with the size of the error increasing for faster speeds and decreasing for slower speeds). Another example of a factor is the number or magnitude of accelerations or decelerations of the vehicle after the last known location was determined (with the size of the error increasing for greater and/or more frequent accelerations or decelerations and decreasing for smaller and/or fewer accelerations or decelerations). Another example of a factor is the number or magnitude of turns of the vehicle after the last known location was determined (with the size of the error increasing for more turns and/or sharper turns and decreasing for fewer and/or less sharp turns).

In the example of FIG. 3, the VCS controller, the vehicle controller, and/or the navigation device can determine that the vehicle (or vehicle system) is located on a selected route 102A of the routes. This route is selected as the error bounds (e.g., the circle in FIG. 3) extends over only a single route. This route may be automatically selected by the controller(s) and/or navigation device, and reported to the back-office system, without operator intervention in one example. Optionally, this route may be automatically selected by the controller(s) and/or navigation device, presented to the operator, and reported to the back-office system once the operator confirms the selected route (e.g., via the I/O device).

In the example of FIG. 4, the VCS controller, the vehicle controller, and/or the navigation device can determine that the vehicle (or vehicle system) is located on one of several potential routes 102B, 102C. These routes may be selected as potential routes due to the error bounds (e.g., the circle in FIG. 4) extending over these two routes. These routes may be presented to the operator, and the operator can select the route 102B or 102C from these presented routes for reporting to the back-office system. This can reduce the potential for human error by requesting that the operator select the route from a thinned down or reduced list of potential routes based on the calculated location and the error bounds extending around the calculated location.

In the example of FIG. 5, the VCS controller, the vehicle controller, and/or the navigation device can determine that the vehicle (or vehicle system) is located on one of several potential routes 102D, 102E, 102F, 102G. These routes may be selected as potential routes due to the error bounds (e.g., the circle in FIG. 5) extending over these two routes. These routes may be presented to the operator, and the operator can select the route 102D, 102E, 102F, or 102G from these presented routes for reporting to the back-office system. This can reduce the potential for human error by requesting that the operator select the route from a thinned down or reduced list of potential routes based on the calculated location and the error bounds extending around the calculated location.

The vehicle controller and the VCS controller can then begin a new trip with the vehicle or vehicle system identified as starting on the automatically selected route, or the route selected by an operator from an automatically selected list of routes. While one embodiment described herein relates to using the calculated location (and error bounds) for establishing protection by the back-office system (such as a PTC system), not all embodiments are limited to back-office system operation, PTC systems, rail vehicles, or the like. For example, the inventive subject matter described herein may be used in connection with other vehicles (e.g., automobiles), trucks, mining vehicles, marine vessels, or the like, to calculate potential locations of the vehicles using both sensed and calculated locations (e.g., in areas where the signals from the location data sources are not available).

In one embodiment, the control system may have a local data collection system deployed that may use machine learning to enable derivation-based learning outcomes. The controller(s) may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller(s) may include a policy engine that may apply to one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the outputs from the various models are obtained, they may be evaluated on their performance using a determined success metric. The best model is selected, and the vehicle controller executes that plan to achieve the desired input data to mirror the predicted best outcome scenario. Additionally, the success metric may be a combination of optimized outcomes, which may be weighed relative to each other.

The controller(s) can use this artificial intelligence or machine learning to receive input (e.g., a sensed location, moving speed of the vehicle, heading and/or change in heading of the vehicle, etc.), use a model that associates inputs or combinations of inputs with different calculated locations, different error bounds, and/or different routes within a blocking structure to select a calculated location, error bound, and/or route, and then provide an output (e.g., the calculated location, error bound, and/or route selected using the model). The controller(s) may receive additional input or feedback, such as an actual error or difference between the calculated location and actual location of the vehicle, the actual route on which the vehicle is located, etc. Based on this additional input, the controller(s) can change the model, such as by changing which calculated location, error bound, and/or route would be selected when a similar or identical input is provided the next time or iteration. The controller(s) can then use the changed or updated model again to calculate the calculated location, calculate an error bound, select a route, etc., receive feedback on the selected location/error/route, change or update the model again, etc., in additional iterations to repeatedly improve or change the model using artificial intelligence or machine learning.

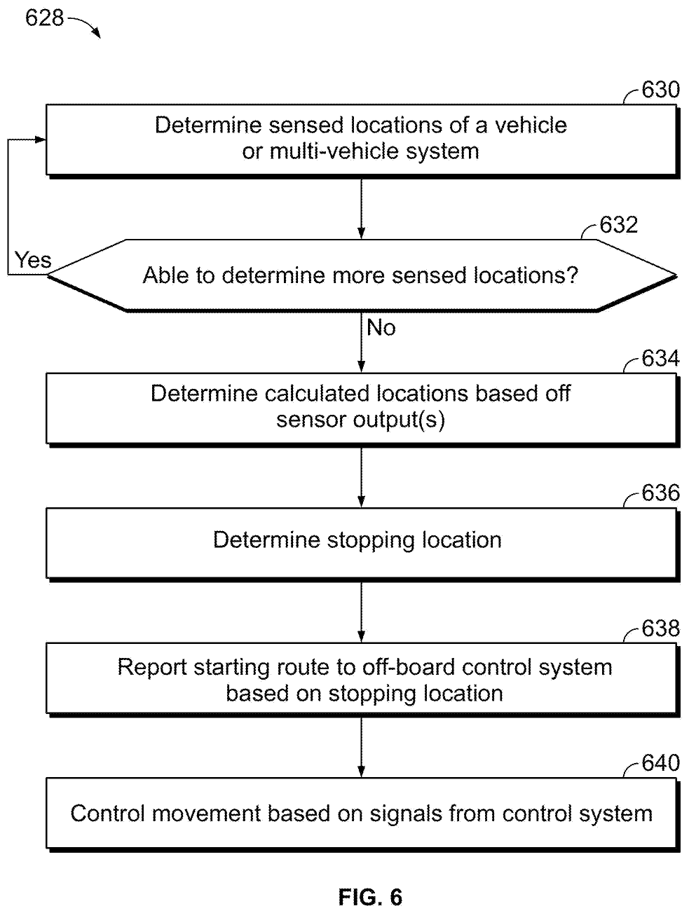

FIG. 6 illustrates a flowchart of one example of a method 628 for determining locations of vehicles. The method can represent operations performed by the control system shown in FIG. 2 to determine locations of vehicles while the vehicles are in locations where external signals (e.g., GNSS signals from the location data sources) may not be available or received. At step 630, one or more sensed locations of the vehicle are determined. These locations can be determined (e.g., calculated) using signals received from off-board sources, such as satellite signals. Alternatively, these locations may be sensed using one or more sensors such as cameras (e.g., reaching or optically detecting location), RFID devices, etc.

At step 632, a determination is made as to whether the vehicle is unable to determine locations of the vehicle from the off-board sources. For example, a decision may be made as to whether the vehicle can continue to sense or determine locations based on signals received from the off-board sources (e.g., satellites). If the vehicle can no longer determine its location from the signals sent by off-board sources (or by sensing objects outside of the vehicle), then the vehicle may no longer be able to determine its sensed location. As a result, flow of the method can proceed toward step 634. If the vehicle can still determine its location from the signals sent by the off-board sources, then the vehicle can continue to determine its location from the signals sent by the off-board sources. As a result, flow of the method can return toward step 630 or may terminate.

At step 634, locations of the vehicle are determined based on output from one or more sensors (e.g., a navigation device). For example, one or more locations of the vehicle may be determined by sensing the speed, heading, vibration, etc. of the vehicle and using a dead reckoning calculation. This can allow for the locations of the vehicle to be determined even though the signals from the off-board sources may not be able to be used for determining the vehicle location. For example, the vehicle can use one or more inertial measurement sensors or units for tracking movements of the vehicle and can calculate locations of the vehicle using dead reckoning.

At step 636, the vehicle may determine the final or stopping location of the vehicle from a completed trip. For example, the VCS controller, vehicle controller, and/or navigation device can determine whether the vehicle has stopped and can calculate the stopped location of the vehicle using the information determined at step 634.

At step 638, a location is reported from the vehicle to an off-board system, such as the back-office system, for protective monitoring of the vehicle. For example, the route on which the vehicle is located may be reported to the back-office system. This route can be selected based on the calculated location of the vehicle (e.g., determined at step 636), as described above. Optionally, several routes may be presented for selection to an operator of the vehicle based on the location determined at step 636, as described above. The selected route may represent the location of the vehicle or vehicle system.

At step 640, movement of the vehicle or vehicle system is controlled based on signals received from the back-office system (that are, in turn, based on the location reported at step 638). For example, the VCS controller may automatically slow or stop movement of the vehicle, may control steering of the vehicle, or the like, based on signals received from the back-office system, as described above. Flow of the method may return to one or more operations or may terminate.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy). In one example, a method (e.g., for initializing a vehicle for movement under or with the protection of a vehicle control system) is provided. The method may include determining a sensed location of a vehicle based off one or more location signals received from an off-board source, and calculating a calculated location of the vehicle responsive to the vehicle moving into a blocking structure where the vehicle does not determine the sensed location of the vehicle based off the one or more location signals. The calculated location of the vehicle may be calculated using one or more sensor outputs. The method also may include selecting a route from among several routes within the blocking structure based on the calculated location, communicating the route that is selected to a back-office system, and controlling movement of the vehicle using one or more control signals received from the back-office system that are based on the route that is selected.

The one or more location signals may be GNSS signals received from one or more GNSS satellites as the off-board source. The calculated location may be calculated using a dead reckoning calculation. The calculated location may be calculated using one or more of vehicle speeds, vehicle vibrations, and/or vehicle headings as the one or more sensor outputs. Optionally, the method also may include sensing movement of the vehicle using an onboard inertial measurement unit to obtain the one or more sensor outputs.

The vehicle may be unable to receive the one or more location signals while the vehicle is in the blocking structure. The calculated location may be calculated as the stopping location of the vehicle from a first trip and as a starting location for a subsequent second trip. The route that is selected may be selected by identifying the several routes that are within an error range around the calculated location.

The route that is selected may be automatically selected based on the calculated location. The method optionally may include presenting the several routes to an operator of the vehicle and receiving a selection of the route that is selected based on the several routes being presented.

In one example, a system (e.g., a vehicle control system) is provided. The system may include one or more controllers that may determine a sensed location of a vehicle based off one or more location signals received from an off-board source. The one or more controllers may calculate a calculated location of the vehicle responsive to the vehicle moving into a blocking structure where the vehicle does not determine the sensed location of the vehicle based off the one or more location signals. The calculated location of the vehicle may be calculated using one or more sensor outputs. The one or more controllers may select a route from among several routes within the blocking structure based on the calculated location and to communicate the route that is selected to a back office system and may control movement of the vehicle using one or more control signals received from the back office system that are based on the route that is selected.

Optionally, the one or more controllers may receive the one or more location signals as GNSS signals received from one or more GNSS satellites as the off-board source. The one or more controllers may calculate the calculated location using a dead reckoning calculation. The one or more controllers may calculate the calculated location using one or more of vehicle speeds, vehicle vibrations, and/or vehicle headings as the one or more sensor outputs.

The system optionally may include an onboard inertial measurement unit that may output sensed movement of the vehicle as the one or more sensor outputs and/or a locator device that may receive the one or more location signals while the vehicle is outside the blocking structure but unable to receive the one or more location signals while the vehicle is in the blocking structure.

The one or more controllers may calculate the calculated location as a stopping location of the vehicle from a first trip and as a starting location for a subsequent second trip. The one or more controllers may select the route by identifying the several routes that are within an error range around the calculated location. The one or more controllers may automatically select the route that is selected based on the calculated location. The one or more controllers may direct presentation of the several routes to an operator of the vehicle and may receive a selection of the route that is selected based on the several routes being presented.

In one example, a method may include determining sensed locations of a vehicle while the vehicle receives GNSS signals, sensing movement of the vehicle using one or more inertial measurement sensors, calculating one or more calculated locations of the vehicle based on at least one of the sensed locations and the movement of the vehicle that is sensed using the one or more inertial measurement sensors and responsive to no longer receiving the GNSS signals, selecting a route from several different routes as a beginning route for a trip of the vehicle (where the beginning route is selected based on the one or more calculated locations), initializing the vehicle for the trip by communicating the beginning route of the vehicle to an off-board system of a positive control system, and controlling movement of the vehicle based on one or more control signals received from the off-board system responsive to initializing the vehicle for the trip.

In one embodiment, the controllers or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination or calculation can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, it may be evaluated on its performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
determining a sensed location of a vehicle based off one or more location signals received from an off-board source;
calculating a calculated location of the vehicle responsive to the vehicle moving into a blocking structure where the vehicle does not determine the sensed location of the vehicle based off the one or more location signals, the calculated location of the vehicle calculated using one or more sensor outputs;
selecting a route from among several routes within the blocking structure based on the calculated location;
communicating the route that is selected to a back-office system; and
controlling movement of the vehicle using one or more control signals received from the back-office system that are based at least in part on the route that is selected.

2. The method of claim 1, wherein the one or more location signals are Global Navigation Satellite System (GNSS) signals received from one or more GNSS satellites as the off-board source.

3. The method of claim 1, wherein the calculated location is calculated using a dead reckoning calculation.

4. The method of claim 1, wherein the calculated location is calculated using one or more of vehicle speeds, vehicle vibrations, or vehicle headings as the one or more sensor outputs.

5. The method of claim 1, further comprising sensing movement of the vehicle using an onboard inertial measurement unit to obtain the one or more sensor outputs.

6. The method of claim 1, wherein the vehicle is unable to receive the one or more location signals while the vehicle is in the blocking structure.

7. The method of claim 1, wherein the calculated location is calculated as a stopping location of the vehicle from a first trip and as a starting location for a subsequent second trip.

8. The method of claim 1, wherein the route that is selected is selected by identifying the several routes that are within an error range around the calculated location.

9. The method of claim 1, wherein the route that is selected is automatically selected based on the calculated location.

10. The method of claim 1, further comprising presenting the several routes to an operator of the vehicle and receiving a selection of the route that is selected based on the several routes being presented.

11. A system comprising:
one or more processors configured to determine a sensed location of a vehicle based off one or more location signals received from an off-board source, the one or more processors being configured to calculate a calculated location of the vehicle responsive to the vehicle moving into a blocking structure where the vehicle does not determine the sensed location of the vehicle based off the one or more location signals, the calculated location of the vehicle calculated using one or more sensor outputs, the one or more processors configured to select a route from among several routes within the blocking structure based on the calculated location and to communicate the route that is selected to a back office system, the one or more processors configured to control movement of the vehicle using one or more control signals received from the back office system that are based on the route that is selected.

12. The system of claim 11, wherein the one or more processors are configured to receive the one or more location signals as Global Navigation Satellite System (GNSS) signals received from one or more GNSS satellites as the off-board source.

13. The system of claim 11, wherein the one or more processors are configured to calculate the calculated location using a dead reckoning calculation.

14. The system of claim 11, wherein the one or more processors are configured to calculate the calculated location using one or more of vehicle speeds, vehicle vibrations, or vehicle headings as the one or more sensor outputs.

15. The system of claim 11, further comprising an onboard inertial measurement unit configured to output sensed movement of the vehicle as the one or more sensor outputs.

16. The system of claim 11, further comprising a locator device configured to receive the one or more location signals while the vehicle is outside the blocking structure but unable to receive the one or more location signals while the vehicle is in the blocking structure.

17. The system of claim 11, wherein the one or more processors are configured to calculate the calculated location as a stopping location of the vehicle from a first trip and as a starting location for a subsequent second trip.

18. The system of claim 11, wherein the one or more processors are configured to select the route by identifying the several routes that are within an error range around the calculated location.

19. The system of claim 11, wherein the one or more processors are configured to automatically select the route that is selected based on the calculated location.

20. A method comprising:
determining sensed locations of a vehicle while the vehicle receives Global Navigation Satellite System (GNSS) signals;
sensing movement of the vehicle using one or more inertial measurement sensors;
responsive to no longer receiving the GNSS signals, calculating one or more calculated locations of the vehicle based on at least one of the sensed locations and the movement of the vehicle that is sensed using the one or more inertial measurement sensors;
selecting a route from several different routes as a beginning route for a trip of the vehicle, the beginning route selected based on the one or more calculated locations;
initializing the vehicle for the trip by communicating the beginning route of the vehicle to an off-board system of a positive control system; and
controlling movement of the vehicle based at least in part on one or more control signals received from the off-board system responsive to initializing the vehicle for the trip.
